(19) United States
(12) Patent Application Publication
(10) Pub. No.: US 2026/0280257 A1
(43) Pub. Date: Sep. 17, 2026

(54) Fastening Device for Fastening in Particular a Cable, a Cable Harness or a Line to an Edge or Rib of a Base Part

(71) Applicant: Illinois Tool Works Inc., Glenview, IL (US)

(72) Inventors: Christian Pfeiffer, Münchweiler (DE); Thiemo Ammann, Rockenhausen (DE); Christian Scherer, Rodgau (DE)

(21) Appl. No.: 19/552,232

(22) Filed: Feb. 27, 2026

(30) Foreign Application Priority Data
Mar. 13, 2025 (DE) 10 2025 109 579.5

(51) Int. Cl. H02G 3/32; F16L 3/04

(52) U.S. Cl. CPC H02G 3/32; F16L 3/04

(57) ABSTRACT

A fastening apparatus (1) for fastening a cable to a rib (100) of a base part. The fastening apparatus (1) includes a base body (2), which can be fitted onto the rib (100). The fastening apparatus (1) further includes a clip (4) operatively connected to the base body (2), wherein at least one bar area (5) of the clip (4) projects into a receiving area (3) of the base body (2) such that, in a state of the rib (100) being received into the receiving area (3), the base body (2) is clamped to the rib (100). According to the disclosure, it is particularly provided that the base body (2) includes a screw boss area (6) with a screw channel (7), wherein the screw channel (7) is connected to the receiving area (3) via a window area (8), so that the rib (100) partially projects into the screw channel (7). When a screw (9) is screwed into the screw channel (7), it firstly forms a form-fitting connection with the screw boss area (6), and secondly forms such a connection with the area of the rib (100) of the base part projecting into the screw channel (7) on the other hand.

### RELATED APPLICATIONS

The present application claims the benefit of German Patent Application No. DE 10 2025 109 579.5, filed Mar. 13, 2025, and titled “Fastening Device for Fastening in Particular a Cable, a Cable Harness or a Line to an Edge or Rib of a Base Part” the contents of which are hereby incorporated by reference.

### BACKGROUND

In the automotive industry in particular, different fastening apparatuses are known with which individual cables or cable harnesses can be fixed to a sheet metal part, for example. To attach the fastening apparatus to the sheet metal part, or generally to a base part, the mounting device typically comprises one or more openings into which the locking elements of the fastening apparatus are pressed. When routing cables, there may be a need for cable fixation to or along an edge of a base part.

For example, a fastening apparatus for cables is known from the publication DE 20 2007 000 938 U1, wherein the fastening apparatus comprises an edge clip part and a cable band with a cable strap lock connected integrally to the edge clip part. The fastening apparatus known from this prior art allows a cable to be fastened in a predetermined direction to an edge of a base part.

On the other hand, a fastening apparatus for cables is known from the publication DE 10 2008 059 360 A1, wherein the fastening apparatus known from this prior art comprises an edge clip part for attaching the fastening apparatus to an edge of a base part and a holding device for at least one cable strap. The holding device comprises fastening sections that form a bracket for the cable strap in three directions that are orthogonally orientated with respect to each other.

Based on this prior art, the disclosure is based on the problem of providing a fastening apparatus that can be used as flexibly as possible, in particular for a cable, for a cable harness, or for a line, which allows the most reliable possible fixation of the cable, the cable harness or the line relative to an edge or a rib of a base part.

### SUMMARY

The present disclosure relates generally to a fastening apparatus, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates schematically and in an isometric view, an exemplary embodiment of the fastening apparatus according to the disclosure in a state, in which the fastening apparatus is not yet fitted onto an edge or rib of the base part;

FIG. 2 illustrates schematically and in a sectional view, the exemplary embodiment of the fastening apparatus according to the disclosure of FIG. 1 in a state, in which the fastening apparatus is fitted onto the edge or rib of the base part, wherein the screw of the fastening apparatus is not yet turned or screwed into the screw channel of the screw boss area of the base body of the fastening apparatus;

FIG. 3 illustrates schematically and in a sectional view, the fastening apparatus according to FIG. 2, specifically in a state in which the screw of the fastening apparatus is turned or screwed into the screw channel of the screw boss area of the base body of the fastening apparatus and forms a form-fitting connection with an area of the edge or rib of the base part;

FIG. 4 illustrates schematically and in an isometric view, a further (second) exemplary embodiment of the fastening apparatus according to the disclosure, specifically in a state in which the fastening apparatus is not yet fitted onto the edge or rib of the base part;

FIG. 5 illustrates schematically and in a sectional view, the further exemplary embodiment of the fastening apparatus according to the disclosure of FIG. 4, specifically in a state in which the fastening apparatus is fitted onto the edge or rib of the base part, wherein the screw of the fastening apparatus is not yet screwed or turned into the screw channel of the screw boss area of the base body of the fastening apparatus; and

FIG. 6 illustrates schematically and in a sectional view, the further exemplary embodiment of the fastening apparatus according to the disclosure of FIG. 5, specifically in a state in which the screw of the fastening apparatus is screwed or turned into the screw channel of the screw boss area of the base body of the fastening apparatus, such that at least one arm or bar area of the clip of the fastening apparatus forms a form-fitting and/or frictional connection with an area of the edge or rib of the base part.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a fastening apparatus for fastening a component to a vehicle part. In particular, the present disclosure relates to a fastening apparatus for fastening, in particular a cable, a cable harness or a line to an edge or rib of a base part.

Accordingly, according to one aspect, the disclosure relates to a fastening apparatus for fastening in particular a cable, a cable harness or a line to an edge or rib of a base part, wherein the fastening apparatus comprises a base body. In the base body of the fastening apparatus, a receiving area is formed, which is at least partially or in areas at least substantially configured with respect to the edge or rib of the base part such that the base body can be fitted onto the edge or rib of the base part while simultaneously receiving at least one area of the edge or rib.

In particular, the base body of the fastening apparatus according to the disclosure is embodied as an “edge clip part” in accordance with DE 20 2007 000 938 U1 or in accordance with DE 10 2008 059 360 A1.

In addition to the base body, the fastening apparatus according to the disclosure comprises a clip connected directly to the base body, in particular a metal clip. It is provided that at least one arm or bar area of the clip projects at least partially or in areas into the receiving area of the base body of the fastening apparatus, such that, in a state of the edge or rib of the base part being received in the receiving area, the base body of the fastening apparatus is held, and in particular fixed in place, at least by friction, in particular by clamping, to the edge or rib of the base part.

By providing such a clip operatively connected to the base body of the fastening apparatus, the fastening apparatus is at least preliminarily fixed in place and held by clamp to the edge or rib of the base part when the edge or rib of the base part is at least partially received in the receiving area of the base body. This applies in particular if the base body with the clip operatively connected to the base body is fitted onto the edge or rib of the base part.

The fastening apparatus according to the disclosure according to the first aspect of the disclosure, wherein the base body of the fastening apparatus comprises a screw boss area with a screw channel extending in the longitudinal direction of the screw boss area. It is provided that the screw channel is connected to the receiving area via a window area, which is in particular facing toward the receiving area of the base body. The window area is configured such that, in a state of the edge or rib of the base part being received in the receiving area, the edge or rib of the base part at least partially or in areas projects into the screw channel.

In addition to the screw boss area with the screw channel extending in the longitudinal direction of the screw boss area, the fastening apparatus according to the disclosure further comprises a particularly self-tapping screw that can be turned or screwed into the screw channel, wherein the screw channel with the window area is configured such that, in the state of being turned or screwed into the screw channel, the screw is connected to the screw boss area and to the area of the edge or rib of the base part projecting into the screw channel, forming at least a form-fitting connection and preferably a form-fitting and frictional connection.

The advantages achievable with the solution according to the disclosure are obvious: by providing a corresponding screw boss area with a screw channel extending in the longitudinal direction of the screw boss area and a particularly self-tapping screw that can be turned or screwed into the screw channel, which, in the state of being turned or screwed into the screw channel, forms at least a form-fitting connection with the screw boss area and with the area of the edge or rib of the base part projecting into the screw channel, a highly reliable fixation of the cable, the cable harness, or the line to the edge or rib of the base part can be realized. In particular, the fastening apparatus provides maximum retention force in the state of the screw being turned or screwed into the screw channel, and thus forms at least a form-fitting connection with both the screw boss area and the area of the edge or rib of the base part projecting into the screw channel.

Additionally, the disclosure creates a cost-effectively manufacturable and yet easy-to-assemble fastening apparatus.

According to embodiments of the fastening apparatus according to the disclosure, it is conceivable that the screw channel extending in the longitudinal direction of the screw boss area is provided with an internal thread adapted to an external thread of the screw at least in areas.

However, this embodiment is not to be considered limiting. It is thus particularly conceivable that the screw channel extending in the longitudinal direction of the screw boss area is provided without internal threads. The screw should be designed as a self-tapping screw in such a way that, when the screw is screwed into the screw channel, the counter-thread corresponding to the thread of the screw is cut. The screw channel into which the self-tapping screw is to be screwed comprises an inner wall, which is formed in areas by the screw boss area of the base body of the fastening apparatus on one hand, and by the area of the edge or rib of the base part projecting through the window area on the other hand.

According to implementations of the fastening apparatus according to the disclosure, the clip operatively connected to the base body of the fastening apparatus comprises at least one arm or bar area, which is configured to form a frictional and/or form-fitting connection with the edge or rib of the base part in a state of the edge or rib being received in the receiving area. A frictional and form-fitting connection is preferably present when the edge or rib of the base part is formed from a relatively soft material, such as a plastic material. A frictional connection is particularly present when the edge or rib of the base part is formed from a relatively hard material, such as steel or a similar metal.

According to embodiments of the fastening apparatus according to the disclosure, it is provided that the clip is configured as a single-sided clip such that, in the state of being operatively connected to the base body of the fastening apparatus, the clip is only present in a section of the receiving area opposite to the window area.

However, it is of course also conceivable to configure the clip as a two-sided clip, which in particular has a substantially U-shaped configuration in the cross-section.

In order to achieve as optimal a clamping effect as possible of the clip operatively connected to the base body of the fastening apparatus, it is provided according to embodiments of the fastening apparatus according to the disclosure, that to fix the clip to the base body, the clip comprises at least one, and preferably at least two, in particular at least substantially opposite holding areas, wherein the at least one holding area of the clip, and in particular the at least two holding areas of the clip, is associated with a recess area arranged in the wall area of the base body delimiting the receiving area, in which the at least one holding area of the clip is received or receivable in a form-fitting and/or frictional manner.

The disclosure further relates to a corresponding kit for fastening, in particular a cable, a cable harness, or a line to an edge or rib of a base part. The fastening kit comprises at least one fastening apparatus of the type according to the disclosure described above, wherein the screw of the fastening apparatus comprises a screw shaft with an external thread, in particular a self-tapping external thread, and with a screw drive at an end area of the screw shaft.

In addition, the fastening kit according to the disclosure includes a corresponding installation tool with a rotating output as needed, which is designed and configured to accommodate the screw drive, to introduce a required torque into the screw drive as needed to screw the screw shaft of the screw into the screw channel formed in the screw boss area.

It is conceivable that the fastening kit further comprises torque monitoring, via which the torque introduced into the screw drive via the rotating output is recorded and/or documented.

Alternatively or additionally, however, it is also conceivable for the screw drive to be connected to the screw shaft of the screw of the fastening apparatus via a predetermined breaking point, wherein this predetermined breaking point is configured such that it responds when a critical torque is applied to the screw drive so that the screw drive at least partially or in areas shears away from the screw shaft.

The underlying problem of the disclosure is also solved, according to a further (second) aspect of the present disclosure. This relates to a fastening apparatus for fastening, in particular a cable, a cable harness or a line to an edge or rib of a base part. The fastening apparatus according to the further aspect of the disclosure comprises a base body in which a receiving area is formed, which is at least partially or in areas at least substantially complementary to the edge or rib of the base part such that the base body can be fitted onto the edge or rib of the base part while simultaneously receiving at least one area of the edge or rib.

The fastening apparatus according to the further (second) aspect of the disclosure also comprises a clip operatively connected to the base body, in particular a metal clip. The clip, in particular a metal clip, comprises at least one arm or bar area, which is configured to form a frictional and/or form-fitting connection to the edge or rib of the base part in a state of the edge or rib of the base part being received in the receiving area and at least in the fully assembled state of the fastening apparatus at the edge or rib of the base part.

In other words, in the figurative sense, the base body can thus form an edge clip part in the sense of DE 20 2007 000 938 U1 or in the sense of DE 10 2008 059 360 A1 together with the clip operatively connected to the base body.

In the fastening apparatus according to the disclosure according to the further (second) aspect of the disclosure, it is particularly provided that the base body of the fastening apparatus comprises a screw boss area with a screw channel extending in the longitudinal direction of the screw boss area. It is provided that the screw channel is connected to the receiving area via a window area, which is in particular facing toward the receiving area of the base body of the fastening apparatus.

In the fastening apparatus according to the disclosure according to the further (second) aspect of the disclosure, it is in particular provided that the window area and the at least one arm or bar area of the clip are configured such that, at least as long as no screw is screwed or turned into the screw channel, the at least one arm or bar area of the clip extends at least partially or in areas into the screw channel.

As with the fastening apparatus according to the disclosure according to the first aspect of the disclosure, the fastening apparatus according to the second aspect of the disclosure further comprises a screw that can be turned or screwed into the screw channel. It is provided that the screw channel with the window area is configured such that, when the screw is turned or screwed into the screw channel, it forces the at least one arm or bar area of the clip through the window area into the receiving area.

As with the fastening apparatus according to the first aspect of the disclosure, the fastening apparatus according to the second aspect of the disclosure provides a maximum holding force, specifically by creating a significantly increased retention force of the fastening apparatus by an additional frictional and/or form-fitting connection, which is induced by turning or screwing in the screw.

In the fastening apparatus according to the first aspect of the disclosure, this additional frictional and/or form-fitting connection is formed by the screw itself, which, when turned in or screwed into the screw channel, turns/cuts into an area of the edge or rib of the base part that extends into the screw channel.

However, in the fastening apparatus according to the second aspect of the disclosure, the additional frictional and/or form-fitting connection is not formed by the screw itself, but rather by the at least one arm or bar area of the clip, which is forced into the receiving area upon turning or screwing the screw into the screw channel through the window area, where the at least one arm or bar area of the clip then forms an (additional) frictional or form-fitting connection with an area of the edge or rib of the base part.

Also, according to the further (second) aspect of the disclosure, the fastening apparatus is inexpensive to manufacture and is easy to assemble, and furthermore a highly reliable cable fixation relative to an edge or rib of a base part is possible.

According to the realizations of the fastening apparatus according to the further (second) aspect of the disclosure, the at least one arm or bar area of the clip is configured such that, when the screw is turned or screwed into the screw channel and, in a state of the edge or rib of the base part being received in the receiving area of the base body, the at least one arm or bar area of the clip forms a form-fitting and/or frictional connection with an area of the edge or rib of the base part received in the receiving area.

Preferably, the screw channel of the base body of the fastening apparatus extending in the longitudinal direction of the screw boss area is provided with an internal thread adapted to an external thread of the screw, at least in areas.

Of course, it is also conceivable that the screw channel is designed without a corresponding internal thread. The screw would then have to be designed as a self-tapping screw.

According to preferred implementations of the fastening apparatus according to the disclosure, the clip comprises two arm or bar areas that are at least substantially parallel to one another, and the screw channel of the base body of the fastening apparatus comprises two window areas that are at least substantially parallel to one another, which are respectively associated with one of the two arm or bar areas of the clip, and by which one of the two arm or bar areas is each forced into the receiving area upon turning or screwing the screw into the screw channel.

This embodiment of the fastening apparatus according to the disclosure provides a particularly reliable fixation of the base body to the edge or rib of the base part.

In conceivable embodiments of the fastening apparatus according to the disclosure, the clip comprises a base body, which is complementary at least partially or in areas to the cross-sectional design of the receiving area of the base body of the fastening apparatus, and which, in the state of the clip being operatively connected to the base body of the fastening apparatus, abuts at least partially or in areas an inner wall area of the receiving area. Of course, however, other embodiments of the clip operatively connected to the base body of the fastening apparatus are also conceivable.

According to a further development, in particular of the most recently mentioned embodiment of the fastening apparatus according to the disclosure, it is provided that the base body of the clip has an at least substantially U-shaped cross-sectional geometry with two leg areas opposite one another. The at least one arm or bar area of the clip is configured at a first leg area of the base body of the clip. At least one additional arm or bar area of the clip is configured at an opposite second leg area of the base body of the clip. In particular, it is provided that even if the screw is not yet turned or screwed into the screw channel, the at least one additional arm or bar area of the clip already projects into the receiving area of the base body of the fastening apparatus, such that, in a state of the edge or rib of the base part being received in the receiving area, the base body of the fastening apparatus is fixed in place, and in particular is preliminarily fixed in place, at least by friction, in particular by clamping, to the edge or rib of the base part.

In embodiments of the fastening apparatus according to the further (second) aspect of the disclosure, it is provided that to fix the clip to the base body of the fastening apparatus, the clip comprises at least one, and preferably at least two, in particular at least substantially opposite holding areas. It is conceivable that the at least one holding area of the clip is associated with a recess area arranged in a wall area of the base body of the fastening apparatus that is delimited by the receiving area, in which the at least one holding area of the clip is received or receivable in a form-fitting and/or frictional manner.

Of course, however, other solutions for fixing the clip to the base body of the fastening apparatus are also conceivable. The clip can in particular also be fixed to the base body of the fastening apparatus by adhesion.

In the fastening apparatus according to the first aspect of the disclosure as well as in the fastening apparatus according to the further (second) aspect of the disclosure, it is particularly provided that at least one holding or fixing device is configured on the base body of the fastening apparatus to hold and/or fix a component, a cable, a cable harness or a line to the base body of the fastening apparatus.

For example, the at least one holding or fixing device may consist of a combination of a cable strap lock and a cable strap that can be inserted into the cable strap lock. Of course, however, other embodiments are also conceivable for the holding or fixing device.

In particular, in the implementations of the fastening apparatus according to the disclosure, it is provided that the base body of the fastening apparatus and the screw boss area of the base body are preferably made of the same plastic material and in particular are formed as one piece. In particular, the base body with the screw boss area can be configured as an injection molding part.

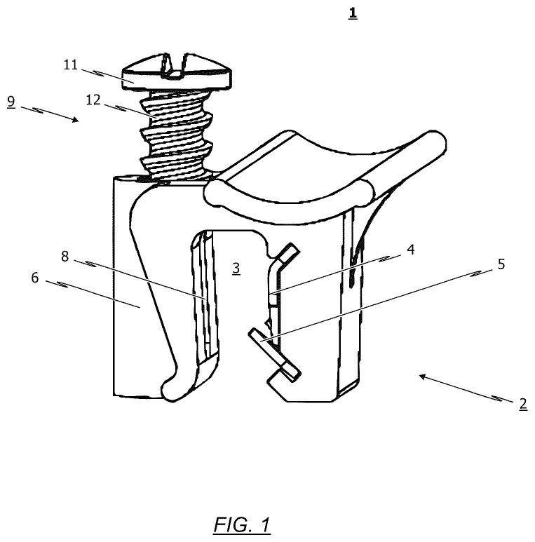

First, referring to the illustrations in FIG. 1 to FIG. 3, a first exemplary embodiment of the fastening apparatus 1 according to the disclosure is described below.

As shown, the fastening apparatus 1 comprises a base body 2, in which a receiving area 3 is formed, which is at least partially or in areas at least substantially complementary to the edge or rib 100 of the base part such that the base body 2 can be fitted onto the edge or rib 100 of the base part while simultaneously receiving at least an area of the edge or rib 100.

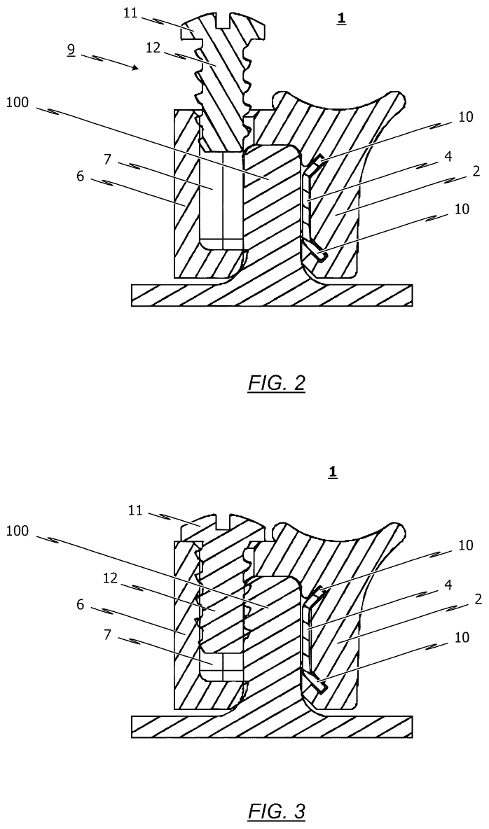

The fitted state of the base body 2 of the fastening apparatus 1 is shown in particular in the sectional view according to FIG. 2.

The first exemplary embodiment of the fastening apparatus 1 according to the disclosure shown in FIG. 1 to FIG. 3 further comprises a clip 4 operatively connected to the base body 2 of the fastening apparatus 1. This is in particular a metal clip.

The clip 4 operatively connected to the base body 2 of the fastening apparatus 1 comprises at least one arm or bar area 5, which projects at least partially or in areas into the receiving area 3 of the base body 2, such that, in a state of the edge or rib 100 of the base part being received in the receiving area 3, the base body 2 of the fastening apparatus 1 is held, and in particular fixed in place, at least by friction, in particular by clamping, to the edge or rib 100 of the base part.

The first exemplary embodiment of the fastening apparatus 1 according to the disclosure in that the base body 2 of the fastening apparatus 1 comprises a screw boss area 6 with a screw channel 7 extending in the longitudinal direction of the screw boss area 6.

As can in particular be seen from the isometric view according to FIG. 1, the screw channel 7 of the screw boss area 6 of the base body 2 is connected to the receiving area 3 via a window area 8 facing toward the receiving area 3 of the base body 2.

From the sectional view according to FIG. 2, it can be seen that the window area 8 is configured such that, in a state of the edge or rib 100 of the base part being received in the receiving area 3, the edge or rib 100 of the base part at least partially or in areas extends into the screw channel 7.

In the first exemplary embodiment of the fastening apparatus 1 according to the disclosure of FIG. 1 to FIG. 3, a screw 9 that can be turned or screwed into the screw channel 7 is also used. In the pre-assembly state of the fastening apparatus 1, as shown in FIG. 1 and FIG. 2, the screw 9 is pre-screwed into the screw channel 7 of the screw boss area 6 of the base body 2.

The screw 9 is in particular a self-tapping screw 9.

The screw channel 7 with the window area 8 is configured such that, in a state of the screw 9 being (at least fully) turned or screwed into the screw channel 7, it firstly forms at least a form-fitting connection with the screw boss area 6 and secondly forms at least such a connection with the area of the edge or rib 100 of the base part that extends into the screw channel 7. This can be seen in FIG. 3.

Although it is generally conceivable that the screw channel 7 extending in the longitudinal direction of the screw boss area 6 is provided with an internal thread adapted to an external thread of the screw 9 at least in areas, the exemplary embodiment of the fastening apparatus 1 according to the disclosure shown in FIG. 1 to FIG. 3 is configured such that the screw channel 7 extending in the longitudinal direction of the screw boss area 6 is provided without an internal thread. The screw 9 is designed as a self-tapping screw 9 such that, when the screw 9 is screwed into the screw channel 7, the inner wall of which is firstly formed in areas by the screw boss area 6 of the base body 2 of the fastening apparatus 1 and is secondly formed by the area of the edge or rib 100 of the base part projecting over the window area 8, the counter-thread that corresponds to the thread of the screw 9 is cut.

As can be seen from the sectional view according to FIG. 2, the at least one arm or bar area 5 of the clip 4 is configured to form a frictional and/or form-fitting connection with the edge or rib 100 of the base part at least in areas in a state of the edge or rib 100 being received in the receiving area 3. This in particular allows the base body 2 to function as an edge clip part in the figurative sense together with the clip 4 operatively connected to the base body 2.

In the first exemplary embodiment of the fastening apparatus 1 according to the disclosure of FIG. 1 to FIG. 3, it is provided that the clip 4 is configured as a single-sided clip 4 such that, in the state of being operatively connected to the base body 2 of the fastening apparatus 1, the clip 4 is only present in a section of the receiving area 3 opposite to the window area 8.

The illustrations in FIG. 1 to FIG. 3 further show that to fix the clip 4 to the base body 2, the clip 4 comprises two at least substantially opposite holding areas 10. Each holding area 10 of the clip 4 is associated with a recess area arranged in a wall area of the base body 2 that is delimited by the receiving area 3, in which a corresponding holding area 10 of the clip 4 is received or receivable in a form-fitting and/or frictional manner.

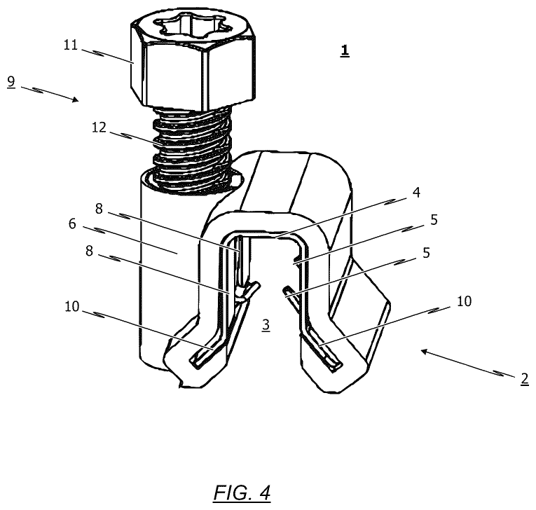

Referring to the illustrations in FIG. 4 to FIG. 6, a further (second) exemplary embodiment of the fastening apparatus 1 according to the disclosure is described in further detail below.

This fastening apparatus 1 is also used for fastening in particular a cable, cable harness or a line (not shown in the drawings) to an edge or rib 100 of a base part.

The second exemplary embodiment of the fastening apparatus 1 according to the disclosure comprises a base body 2, in which a receiving area 3 is formed.

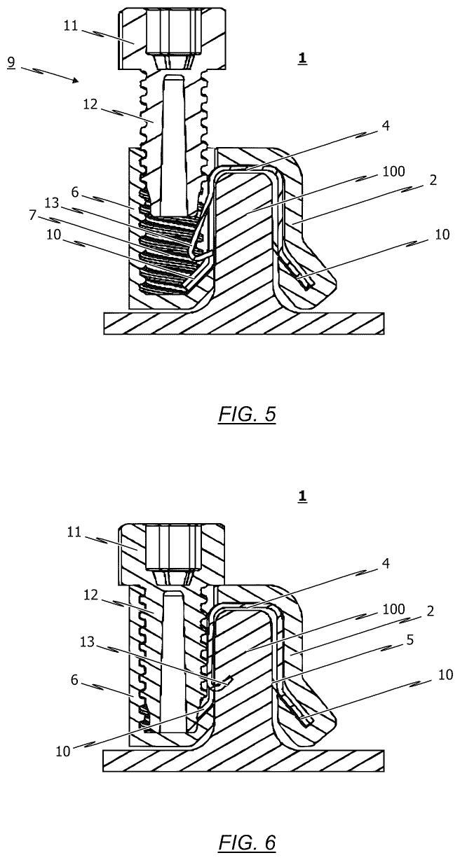

For example, as can be seen from the sectional view according to FIG. 5, the receiving area 3 of the base body 2 is at least partially or in areas at least substantially complementary to the edge or rib 100 of the base part such that the base body 2 of the fastening apparatus 1 can be fitted onto the edge or rib 100 of the base part while simultaneously receiving at least an area of the edge or rib 100 of the base part.

Furthermore, in the second exemplary embodiment of the fastening apparatus 1 according to the disclosure, a clip 4 operatively connected to the base body 2 is used. This is in particular a metal clip.

The clip 4 comprises at least one arm or bar area 13 (in the embodiment shown in FIG. 4 to FIG. 6, the clip 4 has two arm or bar areas 13).

The at least one arm or bar area 13 of the clip 4 is configured to form a frictional and/or form-fitting connection to the edge or rib 100 of the base part in the state of the edge or rib 100 of the base part being received in the receiving area 3 and at least in the fully assembled state of the fastening apparatus 1. The fully assembled state of the fastening apparatus 1 is shown in FIG. 6.

The second exemplary embodiment of the fastening apparatus 1 according to the disclosure in that the base body 2 of the fastening apparatus 1 comprises a screw boss area 6 with a screw channel 7 extending in the longitudinal direction of the screw boss area 6.

In the exemplary embodiment of the fastening apparatus 1 according to the disclosure shown in FIG. 4 to FIG. 6, it is configured such that the screw channel 7 extending in the longitudinal direction of the screw boss area 6 is provided at least in areas with an internal thread adapted to an external thread of a screw 9 of the fastening apparatus 1.

In the pre-assembly state of the fastening apparatus 1 as shown in FIG. 4 and in FIG. 5, the screw 9 of the fastening apparatus 1 is pre-screwed into the screw channel 7.

The screw 9 of the fastening apparatus 1 can be turned or screwed into the screw channel 7. The screw channel 7 with the window area 8 is configured such that, when the screw 9 is turned or screwed into the screw channel 7, it forces the at least one arm or bar area 13 of the clip 4 through the window area 8 into the receiving area 3.

As can in particular be seen in the illustration in FIG. 6, the at least one arm or bar area 13 of the clip 4 is configured such that, when the screw 9 is turned or screwed into the screw channel 7 and, in a state of the edge or rib 100 of the base part being received in the receiving area 3, the at least one arm or bar area 13 of the clip 4 is forced through the window area 8 into the receiving area 3 such that it forms a form-fitting or frictional connection with an area of the edge or rib 100 of the base part received in the receiving area 3.

As already indicated, in the second exemplary embodiment of the fastening apparatus 1 according to the disclosure, as shown schematically in FIG. 4 to FIG. 6, the clip 4 comprises two arm or bar areas 13 that are at least substantially parallel to each other, and the screw channel 7 comprises two window areas 8 that are at least substantially parallel to each other, which are each associated with one of the two arm or bar areas 13 of the clip 4. Through these window areas 8, one of the two arm or bar areas 13 of the clip 4 is each forced into the receiving area 3 upon turning or screwing of the screw 9 into the screw channel 7.

In the second exemplary embodiment of the fastening apparatus 1 according to the disclosure, it is particularly provided that the clip 4 comprises a base body, which is complementary at least partially or in areas to the cross-sectional design of the receiving area 3 of the base body 2, and which, in the state of the clip 4 being operatively connected to the base body 2 of the fastening apparatus 1, abuts at least partially or in areas an inner wall area of the receiving area 3.

In particular, it is provided that the base body of the clip 4 has at least substantially U-shaped cross-sectional geometry with two leg areas opposite each other. The at least one arm or bar area 13 of the clip 4, which in the fully assembled state of the fastening apparatus 1 extends into the receiving area 3 and there forms a form-fitting and/or frictional connection with an area of the edge or rib 100 of the base part received in the receiving area 3, is configured at a first leg area of the base body 2 of the clip 4.

At least one additional arm or bar area 5 of the clip 4 is configured at an opposite second leg area of the base body 2 of the clip 4. It is provided that even if the screw 9 is not yet (at least completely) screwed into the screw channel 7, at least one additional arm or bar area 5 of the clip 4 already projects into the receiving area 3 of the base body 2 of the fastening apparatus 1, such that, in a state of the edge or rib 100 of the base part being received in the receiving area 3, the base body 2 of the fastening apparatus 1 is fixed in place, at least by friction, in particular by clamping, to the edge or rib 100 of the base part.

To attach the clip 4 to the base body 2 of the fastening apparatus 1, the exemplary embodiment of the fastening apparatus 1 shown in FIG. 4 to FIG. 6 provides that the clip 4 comprises at least one and preferably at least two holding areas 10, in particular at least substantially opposite each other, wherein the at least one holding area 10 of the clip 4 is associated with a recess area arranged in a wall area of the base body 2 of the fastening apparatus 1, which recess is delimited by the receiving area 3, in which the at least one holding area 10 of the clip 4 is received or receivable in a form-fitting and/or frictional manner.

Although not shown in the drawings, it is advantageous for the exemplary embodiments of the fastening apparatus 1 to additionally comprise at least one holding or fixing device. The at least one holding or fixing device is preferably configured and formed on the base body 2 of the corresponding fastening apparatus 1 to hold and/or fix in place a component, cable, cable harness or a line to the base body 2 of the fastening apparatus 1.

Preferably, the base body 2 of the fastening apparatus 1 and the screw boss area 6 of the fastening apparatus 1 are each formed from a plastic material and in particular from the same plastic material. It is conceivable that the base body 2 of the fastening apparatus 1 and the screw boss area 6 are formed from one piece.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

1 Fastening apparatus
2 Base body
3 Receiving area
4 Clip
5 Arm or bar area of the clip
6 Screw boss area
7 Screw channel
8 Window area
9 Screw
10 Holding area of the clip
11 Screw drive
12 Screw shaft
13 Arm or bar area of the clip
100 Edge/rib of base part

What is claimed is:

1. A fastening apparatus (1) for fastening a cable, a cable harness or a line to an edge or rib (100) of a base part, wherein the fastening apparatus (1) comprises the following:
a base body (2), in which a receiving area (3) is formed, which is at least partially or in areas at least substantially complementary to the edge or rib (100) of the base part such that the base body (2) can be fitted onto the edge or rib (100) of the base part while simultaneously receiving at least an area of the edge or rib (100); and
a clip (4) operatively connected to the base body (2), wherein at least one arm or bar area (5) of the clip (4) at least partially or in areas projects into the receiving area (3) of the base body (2), such that, in a state of the edge or rib (100) of the base part being received in the receiving area (3), the base body (2) of the fastening apparatus (1) is held at least by clamping to the edge or rib (100) of the base part,
wherein the base body (2) comprises a screw boss area (6) with a screw channel (7) extending in a longitudinal direction of the screw boss area (6), wherein the screw channel (7) is connected to the receiving area (3) via a window area (8) facing particularly toward the receiving area (3) of the base body (2), and wherein the window area (8) is configured in such a manner that, in a state of the edge or rib (100) of the base part being received in the receiving area (3), the edge or rib (100) of the base part at least projects partially or in areas into the screw channel (7); and
wherein the fastening apparatus (1) further comprises a screw (9), which can be turned or screwed into the screw channel (7), wherein the screw channel (7) is configured with the window area (8) such that the screw forms at least one form-fitting connection firstly with the screw boss area (6) and secondly with the area of the edge or rib (100) of the base part projecting into the screw channel (7).

2. The fastening apparatus (1) according to claim 1,
wherein the screw channel (7) extending in the longitudinal direction of the screw boss area (6) is provided with an internal thread adapted to an external thread of the screw (9) at least in areas.

3. The fastening apparatus (1) according to claim 1,
wherein the screw channel (7) extending in the longitudinal direction of the screw boss area (6) is provided without internal threads, and wherein the screw (9) is configured as a self-tapping screw (9), such that, when the screw (9) is screwed into the screw channel (7), the inner wall of which is firstly formed in areas by the screw boss area (6) of the base body (2) of the fastening apparatus (1) and is secondly formed by the area of the edge or rib (100) of the base part projecting over the window area (8), the counter-thread that corresponds to the thread of the screw (9) is cut.

4. The fastening apparatus (1) according to claim 1,
wherein the at least one arm or bar area (5) of the clip (4) is configured to form a frictional and/or form-fitting connection with the edge or rib (100) of the base part in a state of the edge or rib (100) being received in the receiving area (3).

5. The fastening apparatus (1) according to claim 1,
wherein the clip (4) is configured as a single-sided clip (4) such that, in the state of being operatively connected to the base body (2) of the fastening apparatus (1), the clip (4) is only present in a section of the receiving area (3) opposite the window area (8).

6. The fastening apparatus (1) according to claim 1,
wherein, to attach the clip (4) to the base body (2), the clip (4) comprises at least two substantially opposite holding areas (10), wherein the at least one holding area (10) of the clip (4) is associated with a recess area arranged in a wall area of the base body (2) that is delimited by the receiving area (3), in which the at least one holding area (10) of the clip (4) is received or receivable in a form-fitting and/or frictional manner.

7. A kit for fastening a cable, a cable harness, or a line to an edge or rib (100) of a base part, wherein the kit comprises:
at least one fastening apparatus (1) according to claim 1, wherein the screw (9) comprises a screw shaft (12) having an external thread and a screw drive (11) at an end area of the screw shaft (12); and
an installation tool with a rotational output as needed, which is designed and configured to accommodate the screw drive (11), to introduce a required torque into the screw drive (11) as needed to screw the screw shaft (12) of the screw (9) into the screw channel (7) formed in the screw boss area (6).

8. The kit according to claim 7,
wherein the kit further comprises torque monitoring, via which the torque introduced into the screw drive (11) via the rotating output is recorded and/or documented.

9. A fastening apparatus (1) for fastening a cable, a cable harness or a line to an edge or rib (100) of a base part, wherein the fastening apparatus (1) comprises the following:
a base body (2), in which a receiving area (3) is formed, which is at least partially or in areas at least substantially complementary to the edge or rib (100) of the base part such that the base body (2) can be fitted onto the edge or rib (100) of the base part while simultaneously receiving at least an area of the edge or rib (100); and
a clip (4) operatively connected to the base body (2), the clip (4) comprising at least one arm or bar area (13), which is configured to form a form-fitting or frictional connection to the edge or rib (100) of the base part in a state of the edge or rib (100) of the base part being received in the receiving area (3) and at least in the fully assembled state of the fastening apparatus (1),
wherein the base body (2) of the fastening apparatus (1) comprises a screw boss area (6) with a screw channel (7) extending in a longitudinal direction of the screw boss area (6), wherein the screw channel (7) is connected to the receiving area (3) via a window area (8) facing particularly toward the receiving area (3) of the base body (2), and wherein the window area (8) and the at least one arm or bar area (13) of the clip (4) are configured such that, at least as long as no screw (9) is at least fully screwed or turned into the screw channel (7), the at least one arm or bar area (13) of the clip (4) at least projects partially or in areas into the screw channel (7); and
wherein the fastening apparatus (1) further comprises a screw (9), which can be turned or screwed into the screw channel (7), wherein the screw channel (7) is configured with the window area (8) such that when the screw (9) is turned or screwed into the screw channel (7), it forces the at least one arm or bar area (13) of the clip (4) through the window area (8) into the receiving area (3).

10. The fastening apparatus (1) according to claim 9,
wherein the at least one arm or bar area (13) of the clip (4) is configured such that when the screw (9) is turned or screwed into the screw channel (7) and, in a state of the edge or rib (100) of the base part being received in the receiving area (3), the at least one arm or bar area (13) of the clip (4) forms a form-fitting or frictional connection with an area of the edge or rib (100) received in the receiving area (3).

11. The fastening apparatus (1) according to claim 9,
wherein the screw channel (7) extending in the longitudinal direction of the screw boss area (6) is provided with an internal thread adapted to an external thread of the screw (9) at least in areas.

12. The fastening apparatus (1) according to claim 9,
wherein the clip (4) comprises two arm or bar areas (13) that are at least substantially parallel to one another and the screw channel (7) comprises two corresponding window areas (8) that are at least substantially parallel to one another, which are each associated with one of the two arm or bar areas (13) of the clip (4), and by which one of the two arm or bar areas (13) is each forced into the receiving area (3) upon turning or screwing the screw (9) into the screw channel (7).

13. The fastening apparatus (1) according to claim 9,
wherein the clip (4) comprises a base body which is complementary at least partially or in areas to the cross-sectional design of the receiving area (3) and which, in the state of the clip (4) being operatively connected to the base body (2) of the fastening apparatus (1), abuts at least partially or in areas an inner wall area of the receiving area (3).

14. The fastening apparatus (1) according to claim 13,
wherein the base body of the clip (4) has an at least substantially U-shaped cross-sectional geometry with two leg areas opposite one another, wherein the at least one arm or bar area (13) of the clip (4) is arranged at a first leg area of the base body (2) of the clip (4), and wherein at least one additional arm or bar area (5) of the clip (4) is arranged at an opposite second leg area of the base body (2) of the clip (4), wherein even if the screw (9) is not yet turned or screwed into the screw channel (7), the at least one additional arm or bar area (5) of the clip (4) already projects into the receiving area (3) of the base body (2) of the fastening apparatus (1) such that, in a state of the edge or rib (100) of the base part being received in the receiving area (3), the base body (2) of the fastening apparatus (1) is fixed to the edge or rib (100) of the base part at least by means of clamping.

15. The fastening apparatus (1) according to claim 9,
wherein, for attaching the clip (4) to the base body (2) of the fastening apparatus (1), the clip (4) comprises at least two holding areas (10) at least substantially opposite to one another, wherein the at least one holding area (10) of the clip (4) is associated with a recess area arranged in a wall area of the base body (2) of the fastening apparatus (1), which recess area is delimited by the receiving area (3), in which the at least one holding area (10) of the clip (4) is received or receivable in a form-fitting and/or frictional manner.

16. The fastening apparatus (1) according to claim 1,
wherein at least one holding or fixing device is configured on the base body (2) of the fastening apparatus (1) to hold and/or fix in place a component, cable, cable harness or a line to the base body (2) of the fastening apparatus (1).

17. The fastening apparatus (1) according to claim 1,
wherein the base body (2) of the fastening apparatus (1) and the screw boss area (6) are made of the same plastic material and are formed as one piece.
